(19) United States
(12) Patent Application Publication
(10) Pub. No.: US 2017/0018074 A1
(43) Pub. Date: Jan. 19, 2017

(54) SECURITY PROTECTED PART IDENTIFICATION AND METHOD OF PART MANUFACTURE

(71) Applicant: Hamilton Sundstrand Corporation, Charlotte, NC (US)

(72) Inventors: Eric Karlen, Rockford, IL (US); Daniel Ursenbach, Caledonia, IL (US)

(21) Appl. No.: 14/799,224

(22) Filed: Jul. 14, 2015

(51) Int. Cl. G06T 7/00; G06K 9/18; B29C 67/00; G06K 19/06; G06K 9/32

(52) U.S. Cl. CPC G06T 7/0008; G06K 19/06037; G06K 9/3208; G06K 9/3233; B29C 67/0074; G06K 9/18; G06T 2207/10116; G06T 2207/30164; G06T 2207/30204; B33Y 10/00

(57) ABSTRACT

A part identification system includes a part made of at least a first material having a first density, and an identifier made of a second material embedded in the first material and having a second density greater than the first density, and wherein the identifier is visually invisible. A security reader of the system is constructed and arranged to read the identifier and may be a radiographic reader. A method of manufacturing the part may include additive manufacturing.

### BACKGROUND

The present disclosure relates to part identification, and, more particularly, to a part having a security protected part identifier.

Parts and components often require serialization or some form of identification. Such identifiers are typically applied during a manufacturing process as an embedded, engraved, or printed code. These codes (e.g., alphanumeric code, bar code, etc.) are generally visible to the naked eye. Unfortunately, high value components such as, for example, castings can be wrongly duplicated by third party sources and introduced into an original equipment manufacturer's (OEM) supply chain. Such counterfeits or unapproved components may cause failure of the entire assembly, create lost profits, and ultimately harm an OEM's good name. A need to identify and/or differentiate counterfeit and OEM parts exist.

### SUMMARY

A part identification system according to one, non-limiting, embodiment of the present disclosure includes a part made of at least a first material having a first density; and an identifier made of a second material embedded in the first material and having a second density greater than the first density, and wherein the identifier is visually concealed.

Additionally to the foregoing embodiment, the system includes a security reader constructed and arranged to read the identifier.

In the alternative or additionally thereto, in the foregoing embodiment, the security reader is a radiographic device.

In the alternative or additionally thereto, in the foregoing embodiment, the identifier is a serial number.

In the alternative or additionally thereto, in the foregoing embodiment, the identifier is a geometric shape.

In the alternative or additionally thereto, in the foregoing embodiment, the identifier is a dot matrix code.

In the alternative or additionally thereto, in the foregoing embodiment, the identifier is a bar code.

In the alternative or additionally thereto, in the foregoing embodiment, the identifier is a QR code.

In the alternative or additionally thereto, in the foregoing embodiment, the identifier is alphanumeric.

In the alternative or additionally thereto, in the foregoing embodiment, the first material is aluminum and the second material is tungsten.

In the alternative or additionally thereto, in the foregoing embodiment, the identifier includes a first portion lying within a first plane and a second portion lying within a second plane.

In the alternative or additionally thereto, in the foregoing embodiment, the first and second portions are generally parallel to and spaced apart from one-another within the first material.

In the alternative or additionally thereto, in the foregoing embodiment, the system includes a security reader constructed and arranged to read the identifier, and including a line-of-read intersecting and substantially normal to the first and second portions.

In the alternative or additionally thereto, in the foregoing embodiment, the first and second portions are spaced apart from one-another and the respective first and second planes intersect one-another.

In the alternative or additionally thereto, in the foregoing embodiment, the system includes a security reader constructed and arranged to read the identifier, and including a line-of-read intersecting the first and second portions and orientated at a prescribed incident angle with at least one of the first and second planes.

In the alternative or additionally thereto, in the foregoing embodiment, the security reader is configured to produce a recognizable image of the identifier.

In the alternative or additionally thereto, in the foregoing embodiment, at least the identifier is additive manufactured.

A method of manufacturing a part according to another, non-limiting, embodiment includes determining the code of an identifier; selecting a first material of the identifier; selecting a second material of the part with the first material having a density greater than the second material; and concealing the identifier in the part being identified.

Additionally to the foregoing embodiment, concealing the identifier is by embedding the identifier in the part.

In the alternative or additionally thereto, in the foregoing embodiment, at least a portion of the part with the identifier is additive manufactured.

The foregoing features and elements may be combined in various combinations without exclusivity, unless expressly indicated otherwise. These features and elements as well as the operation thereof will become more apparent in light of the following description and the accompanying drawings. However, it should be understood that the following description and drawings are intended to be exemplary in nature and non-limiting.

### BRIEF DESCRIPTION OF THE DRAWINGS

Various features will become apparent to those skilled in the art from the following detailed description of the disclosed non-limiting embodiments. The drawings that accompany the detailed description can be briefly described as follows:

FIG. 1 is a schematic of a part identification system as one, non-limiting, exemplary embodiment of the present disclosure;

FIG. 2 is a schematic of the system illustrating a dot matrix code as an identifier of the system;

FIG. 3 is a schematic of a second embodiment of the system;

FIG. 4 is a schematic of the system illustrating a QR code as the identifier; and

FIG. 5 is a perspective view of an additive manufacturing system use to manufacture a part of the part identification system.

### DETAILED DESCRIPTION

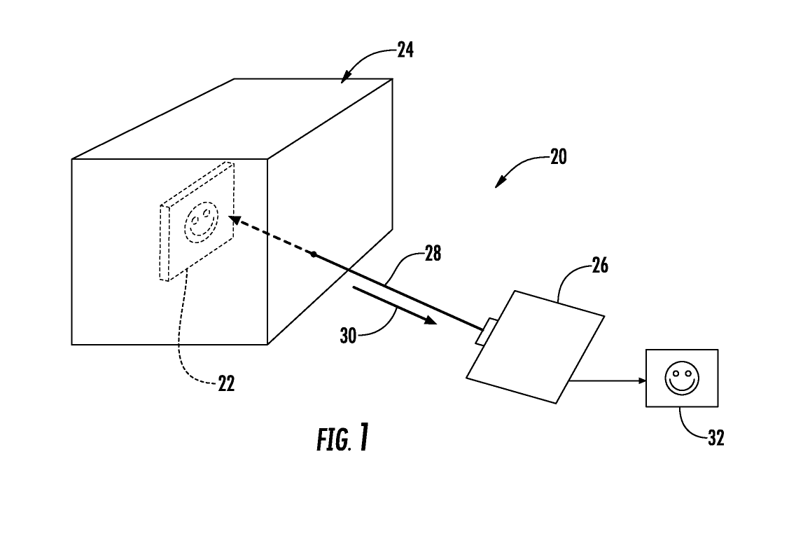

Referring to FIG. 1, an exemplary embodiment of a part identification system 20 is illustrated having a part identifier 22 in a part 24 and a security reader 26. The identifier 22 does not contribute toward the primary function of the part 24, but serves to identify the part while minimizing or eliminating any possibility of being duplicated by a non-OEM or counterfeiting entity. Therefore, the identifier 22 may not be visible to the naked eye or may be orientated such that the identifier is un-recognizable without the proper security reader 26 and reading process.

The part 24 is generally made of a first material having a first density. The identifier 22 is embedded in the first material and is made of a second material that has a density greater than the first density of the first material. The security reader 26 includes a line-of-read beam (see arrow 28) that generally penetrates the first material and senses the second material of the identifier 22. An electrical signal (see arrow 30) returns to the security reader 26 and is processed into what may be a visually readable image 32 by the naked eye. The security reader 26 may, as one non-limiting example, be a radiographic reader, and the line-of-read beam 28 may be an x-ray or ionization ray. As one, non-limiting example, the first material of the part 24 may be aluminum (i.e., aluminum alloy), and the second material of the identifier 22 may be tungsten. It is further contemplated and understood that other types of density differentiating readers may apply to the present disclosure.

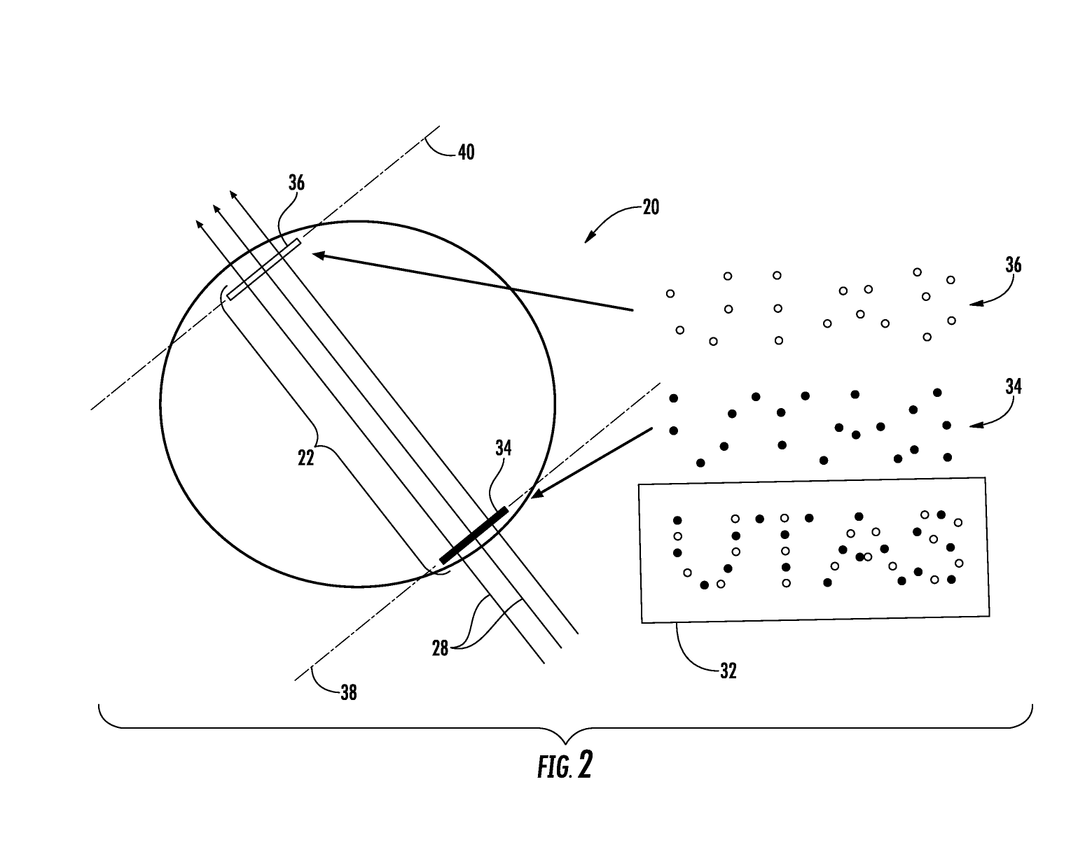

Referring to FIGS. 1 and 2, the part identifier 22 may have a plurality of portions 34, 36 (i.e., two illustrated) each lying within a respective imaginary plane 38, 40. The imaginary planes 38, 40 may be substantially parallel to one-another (and spaced away from one-another) with the beam 28 being substantially normal to the planes 38, 40. That is, the beam 28 may first pass through the first portion 34 of the identifier 22 and then the second portion 36. Each portion 34, 36, on their own, are unreadable (i.e., the identifier 22 remains unknown); however, generally through a single signal 30 developed via a single beam 28, the security reader 26 may process the signal 30, combine the portions 34, 36, and produce an intelligible, readable, image 32 that depicts the identifier 22. Each portion 34, 36 may be in the form of a dot matrix (as illustrated), and the final image 32 may depict the combined dot matrix identifier.

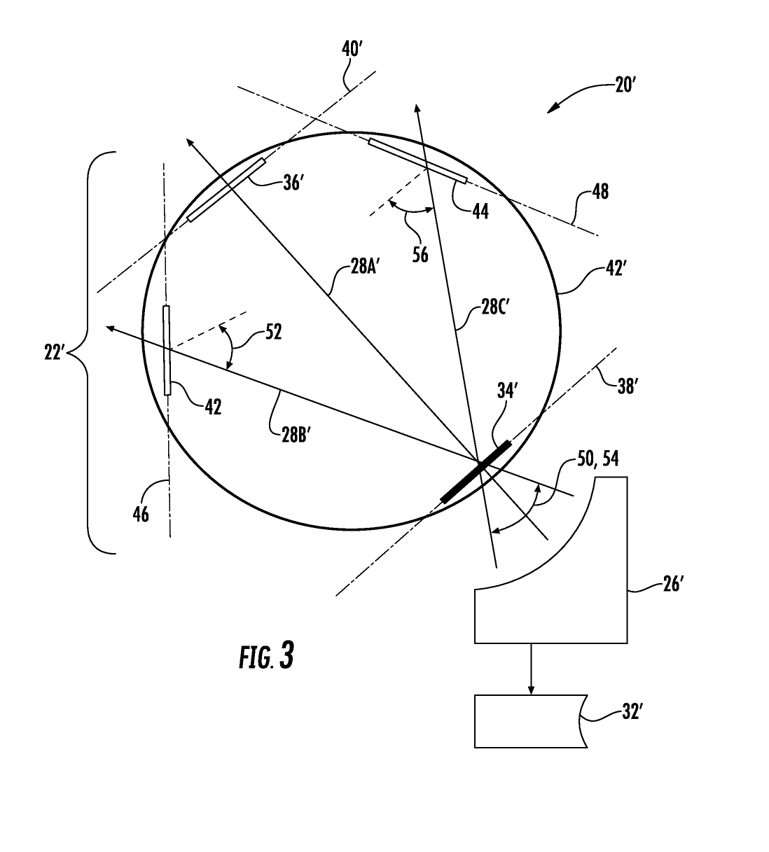

Referring to FIG. 3, a second embodiment of a part identification system is illustrated wherein elements similar to the first embodiment have like identifying numerals (or alphanumeric numerals) except with the addition of a prime symbol as a prefix. The system 20′ of the second embodiment includes a security reader 32′ capable of producing a plurality of beams 28A′, 28B′, 28C′ that may originate from a single beam or may be produced by the security reader 32′ independently. All three beams 28A′, 28B′, 28C′ are configured to pass through a leading portion 34′ of an identifier 22′ either simultaneously or consecutively. After passing through the first portion 34A′, each beam 28A′, 28B′, 28C′ may then pass through a respective trailing or rearward portion 36′, 42, 44 of the identifier 22′.

The portions 34′, 36′ 42, 44 may each lie within respective imaginary planes 38′, 40′ 46, 48. Planes 38′, 40′ may be substantially parallel to one-another, while the planes 46, 48 are angled and therefore intersect each other along with planes 38′, 40′. In one non-limiting example, beam 28′ may be substantially normal to planes 38′, 40′ (i.e., thus generally the portions 34′, 36′). Beam 28B′ may have an incident angle (see arrow 50) with respect to portion 34′ that is between zero and 180 degrees. Similarly, beam 28B′ may form an incident angle (see arrow 52) which respect to portion 42. Also, beam 28C′ may form incident angles 54, 56 with the respective portions 34′, 44. The reader 26′ images all four portions 34′, 36′, 42, 44 lying within respective planes 38′, 40′ 46, 48 and forms one readable image 32′ depicting the identifier 22. Because the portions 34′, 36′, 42, 44 may each lye within a respective plane having a unique, pre-specified, orientation, this orientation must be known (i.e. the incident angles 50, 52, 54, 56) in order to accurate image the identifier 22.

Without knowing the pre-specified orientations of the portions 38′, 40′, 46, 48, a potential counterfeiter is prevented from completely copying the part 24′, since any attempted image made of the counterfeited part using the pre-specified orientations of pre-specified identifier portions would be highly unlikely if not impossible. It is further contemplated and understood that the identifier 22′ may have any number of portions with any number of these portions read by a single beam. Yet further, each portion may be spaced at any pre-determined distance and pre-determined angle. Ultimately, the variety of number portion quantities, spacings (i.e., depth of field) and angles provide a limitless choice of security code combinations.

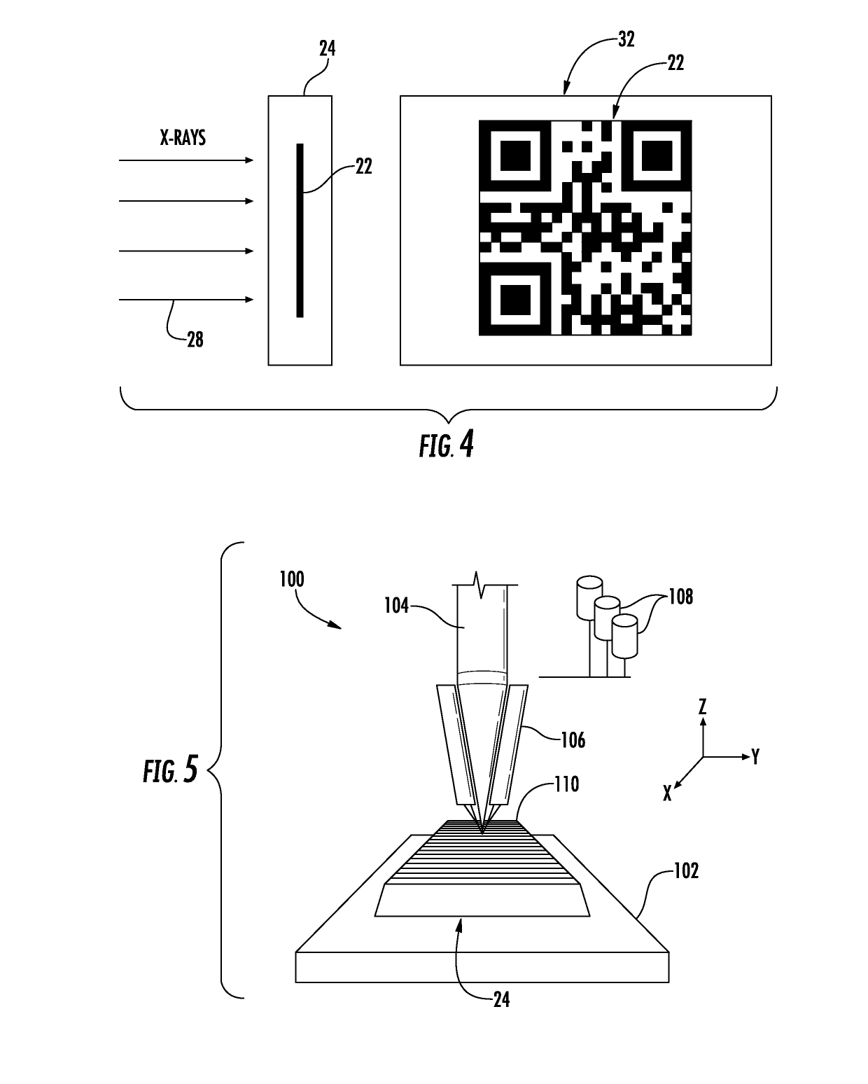

Referring to FIG. 4, the identifier 22 may be a quick response (QR) code as illustrated. Yet further, the identifier 22 may be an alphanumeric identification, a serial number, a machine readable bar code, or any other code having a geometric shape.

Referring to FIG. 5, the identifier 22 and at least a portion of the part 24 may be manufactured by an additive manufacturing system 100. Examples of known additive manufacturing systems may include, but are not limited to, Additive Layer Manufacturing (ALM) devices, such as Direct Metal Laser Sintering (DMLS), Selective Laser Melting (SLM), Laser Beam Melting (LBM), and Electron Beam Melting (ELM) that provide for the fabrication of complex metal, alloy, polymer, ceramic and composite structures by the freeform construction of the workpiece (i.e., part 24), layer-by-layer.

The additive manufacturing system 100, may include an x-y motion bed 102, a focused energy beam device 104, a plurality of powder delivery nozzles 106 and a plurality of hoppers 108. The bed 102 is constructed to move along an x-y plane while supporting the part 24 being manufactured. Each hopper 108 may store a powder consisting of a pre-determined material (e.g., tungsten in one hopper and aluminum in another), and each nozzle 106 may be associated with a respective hopper 108.

In operation, the hoppers 108 feed pre-selected powder to the nozzles 106 that dispense the powder in a localized region on a deposition surface 110 of the workpiece 24. The energy beam device 104 (e.g., laser, electron, etc.), melts the powders into pools at the localized region, which then solidifies as the beam device 104 and nozzles 106 move to the next adjacent region via movement of the bed 102. This process repeats itself until a complete layer of the workpiece 24 is formed, and the system then moves to the next adjacent layer (i.e., z direction) to be manufactured. Although not illustrated, the system may generally be directed by three-dimensional geometry models developed in Computer Aided Design (CAD) software systems.

While the present disclosure is described with reference to exemplary embodiments, it will be understood by those skilled in the art that various changes may be made and equivalents may be substituted without departing from the spirit and scope of the present disclosure. In addition, various modifications may be applied to adapt the teachings of the present disclosure to particular situations, applications, and/or materials, without departing from the essential scope thereof. The present disclosure is thus not limited to the particular examples disclosed herein, but includes all embodiments falling within the scope of the appended claims.

What is claimed is:

1. A part identification system comprising:
a part made of at least a first material having a first density; and
an identifier made of a second material embedded in the first material and having a second density greater than the first density, and wherein the identifier is visually concealed.

2. The part identification system set forth in claim 1 further comprising:
a security reader constructed and arranged to read the identifier.

3. The part identification system set forth in claim 2, wherein the security reader is a radiographic device.

4. The part identification system set forth in claim 1, wherein the identifier is a serial number.

5. The part identification system set forth in claim 1, wherein the identifier is a geometric shape.

6. The part identification system set forth in claim 1, wherein the identifier is a dot matrix code.

7. The part identification system set forth in claim 1, wherein the identifier is a bar code.

8. The part identification system set forth in claim 1, wherein the identifier is a QR code.

9. The part identification system set forth in claim 1, wherein the identifier is alphanumeric.

10. The part identification system set forth in claim 1, wherein the first material is aluminum and the second material is tungsten.

11. The part identification system set forth in claim 1, wherein the identifier includes a first portion lying within a first plane and a second portion lying within a second plane.

12. The part identification system set forth in claim 11, wherein the first and second portions are generally parallel to and spaced apart from one-another within the first material.

13. The part identification system set forth in claim 12 further comprising:
a security reader constructed and arranged to read the identifier, and including a line-of-read intersecting and substantially normal to the first and second portions.

14. The part identification system set forth in claim 11, wherein the first and second portions are spaced apart from one-another and the respective first and second planes intersect one-another.

15. The part identification system set forth in claim 14 further comprising:
a security reader constructed and arranged to read the identifier, and including a line-of-read intersecting the first and second portions and orientated at a prescribed incident angle with at least one of the first and second planes.

16. The part identification system set forth in claim 2, wherein the security reader is configured to produce a recognizable image of the identifier.

17. The part identification system set forth in claim 1, wherein at least the identifier is additive manufactured.

18. A method of manufacturing a part comprising:
determining the code of an identifier;
selecting a first material of the identifier;
selecting a second material of the part with the first material having a density greater than the second material; and
concealing the identifier in the part being identified.

19. The method set forth in claim 18, wherein concealing the identifier is by embedding the identifier in the part.

20. The method set forth in claim 19, wherein at least a portion of the part with the identifier is additive manufactured.
